(19) United States
(12) Patent Application Publication
(10) Pub. No.: US 2026/0307516 A1
(43) Pub. Date: Oct. 8, 2026

(54) CHARGING APPARATUS

(71) Applicant: TOYOTA JIDOSHA KABUSHIKI KAISHA, Toyota-shi Aichi-ken (JP)

(72) Inventor: Tatsuo MIZUNO, Toyota-shi Aichi-ken (JP)

(73) Assignee: TOYOTA JIDOSHA KABUSHIKI KAISHA, Toyota-shi Aichi-ken (JP)

(21) Appl. No.: 19/560,664

(22) Filed: Mar. 9, 2026

(30) Foreign Application Priority Data
Apr. 2, 2025 (JP) 2025-061168

(51) Int. Cl. B60L 53/16; B60L 53/31; H02J 7/70

(52) U.S. Cl. CPC B60L 53/16; B60L 53/31; H02J 7/70

(57) ABSTRACT

In a charging apparatus, a connector includes a distal end portion and a first convex portion. The distal end portion is connected to a vehicle by being inserted into the vehicle. The first convex portion protrudes from the distal end portion in a direction intersecting an inserting direction of the distal end portion to the vehicle. A holder holds the connector when the distal end portion and the first convex portion have been inserted into the holder such that the inserting direction of the distal end portion is along an inserted direction of the holder. A first guide portion and a second guide portion which are included in the holder are arrayed in a circumferential direction orthogonal to the inserted direction, and extend along the inserted direction. The distance between the first guide portion and the second guide portion continuously decreases toward the inserted direction.

### CROSS-REFERENCE TO RELATED APPLICATION

This application claims priority to Japanese Patent Application No. 2025-061168 filed on April 2, 2025. The disclosure of the above-identified application, including the specification, drawings, and claims, is incorporated by reference herein in its entirety.

### BACKGROUND

### 1. Technical Field

The present disclosure relates to a charging apparatus.

### 2. Description of Related Art

Japanese Unexamined Patent Application Publication No. 2013-93976 (JP 2013-93976 A) discloses a conventional charging apparatus. The charging apparatus includes a chassis, a charging gun, and a concave gun pocket. The charging gun is provided at a distal end of a cable brought out from the chassis. The concave gun pocket is provided on the chassis, and houses the charging gun. The concave gun pocket includes a rotation restriction portion and a lock mechanism. The rotation restriction portion restricts the rotation of the charging gun when the charging gun is housed. The lock mechanism is provided on a lower side in the vertical direction of a rotation pivot, and locks the charging gun.

### SUMMARY

In the case where the charging gun (connector) is housed in a holder by being inserted into the holder, the connector can be inserted into the holder, for example, in a state where the positioning of the connector in the rotation direction of the connector with respect to the holder has been previously performed. However, depending on the shape of the connector, it is not easy to perform the positioning of the connector at the start of the insertion into the holder.

The present disclosure provides a charging apparatus that makes it easy to perform the positioning of the connector at the start of the insertion into the holder.

An aspect of the present disclosure relates to a charging apparatus including a connector and a holder. The connector includes a distal end portion and a first convex portion. The distal end portion is configured to be connected to a vehicle by being inserted into the vehicle. The first convex portion protrudes from the distal end portion in a direction intersecting an inserting direction of the distal end portion to the vehicle. The holder is configured to hold the connector when the distal end portion and the first convex portion are inserted into the holder such that the inserting direction of the distal end portion is along an inserted direction of the holder. The holder includes a first guide portion and a second guide portion. The first guide portion and the second guide portion are arrayed in a circumferential direction orthogonal to the inserted direction, and extend along the inserted direction. The distance between the first guide portion and the second guide portion continuously decreases toward the inserted direction.

In the charging apparatus in the aspect of the present disclosure, the outer shape of the first guide portion may be a roughly trapezoidal shape as viewed from a central axis line of the holder.

In the charging apparatus in the aspect and configuration of the present disclosure, the first guide portion and the second guide portion may be provided such that the first convex portion passes between the first guide portion and the second guide portion after the insertion of the distal end portion into the holder is started.

In the charging apparatus in the aspect and configuration of the present disclosure, the first guide portion includes a first inclined surface, and the first inclined surface faces the second guide portion in the circumferential direction and is inclined so as to get close to the second guide portion toward the inserted direction. Moreover, the second guide portion includes a second inclined surface, and the second inclined surface faces the first guide portion in the circumferential direction and is inclined so as to get close to the first guide portion toward the inserted direction.

In the charging apparatus in the aspect and configuration of the present disclosure, the connector may further include a locking portion. The locking portion may be provided at the distal end portion so as to face in a direction intersecting the inserting direction. The holder may further include a first wall portion, a second wall portion, and a locked portion. The first wall portion may extend from the first guide portion in the inserted direction. The second wall portion may extend from the second guide portion in the inserted direction. The locked portion may be provided at one of the first guide portion and the first wall portion. The locking portion may lock the locked portion in an opposite direction of the inserted direction, such that the connector is held by the holder. Moreover, a distal end of the first convex portion in the inserting direction may be positioned between the first wall portion and the second wall portion, when the locking portion has locked the locked portion.

In the charging apparatus having the above configuration, the locked portion may be provided at the first guide portion. Moreover, the size in the inserted direction from a distal end part of the first guide portion in the inserted direction to a rear end edge of the locked portion in the inserted direction may be shorter than the size in the inserting direction from the distal end of the first convex portion to the locking portion.

In the charging apparatus in the aspect and configuration of the present disclosure, the first convex portion may extend parallel to the inserting direction. The holder may further include a first wall portion and a second wall portion. The first wall portion may extend from the first guide portion in the inserted direction. The second wall portion may extend from the second guide portion in the inserted direction. A surface of the first wall portion may be continuous with a surface of the first guide portion in the inserted direction, and may extend parallel to the inserted direction, the surface of the first wall portion being oriented to the second wall portion, the surface of the first guide portion being oriented to the second guide portion. A surface of the second wall portion may be continuous with a surface of the second guide portion in the inserted direction, and may extend parallel to the inserted direction, the surface of the second wall portion being oriented to the first wall portion, the surface of the second guide portion being oriented to the first guide portion.

In the charging apparatus in the aspect and configuration of the present disclosure, the inserted direction may be an obliquely upward direction. Moreover, a gap between the first guide portion and the second guide portion may be positioned on the upper side of the distal end portion when the distal end portion has been inserted into the holder.

In the charging apparatus in the aspect and configuration of the present disclosure, the connector may further include a second convex portion. The second convex portion may protrude from the distal end portion in a direction intersecting the inserting direction. The holder may further include a third guide portion. The third guide portion may be arrayed with the first guide portion in the circumferential direction orthogonal to the inserted direction, and may extend along the inserted direction. Moreover, the distance between the first guide portion and the third guide portion continuously decreases toward the inserted direction.

In the charging apparatus having the above configuration, the first guide portion and the third guide portion may be provided such that the second convex portion passes between the first guide portion and the third guide portion after the insertion of the distal end portion into the holder is started.

The charging apparatus in the aspect and configuration of the present disclosure makes it easy to perform the positioning of the connector at the start of the insertion into the holder.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing a charging apparatus and a vehicle according to an embodiment as an example of the present disclosure;

FIG. 2 is a partial perspective view showing a connector through which electric power is supplied from the charging apparatus to the vehicle;

FIG. 3 is a diagram of the connector as viewed from a direction orthogonal to an inserting direction;

FIG. 4 is a diagram showing the charging apparatus in a state where the connector is held by a holder included in the charging apparatus;

FIG. 5 is a diagram schematically showing a state just before the connector is inserted into the holder;

FIG. 6 is a diagram of the holder as viewed along an inserted direction;

FIG. 7 is a sectional view of the holder in FIG. 6 as viewed along arrow VII-VII;

FIG. 8 is a diagram showing an example of a state just after the insertion of the connector into the holder is started, as viewed along the inserted direction;

FIG. 9 is a schematic diagram showing the example of the state just after the insertion of the connector into the holder is started, as viewed in a direction orthogonal to the inserted direction;

FIG. 10 is a diagram showing a different example of the state just after the insertion of the connector into the holder is started, as viewed along the inserted direction;

FIG. 11 is a schematic diagram showing the different example of the state just after the insertion of the connector into the holder is started, as viewed in the direction orthogonal to the inserted direction;

FIG. 12 is a diagram showing a state where a first convex portion included in the connector has advanced to a distal end part of a first guide portion included in the holder, as viewed along the inserted direction;

FIG. 13 is a schematic diagram showing the state where the first convex portion has advanced to the distal end part of the first guide portion, as viewed in the direction orthogonal to the inserted direction;

FIG. 14 is a schematic diagram showing a state where the first convex portion is advancing between a first wall portion and a second wall portion, as viewed in the direction orthogonal to the inserted direction;

FIG. 15 is a schematic diagram showing a state where the connector is held by the holder, as viewed in the direction orthogonal to the inserted direction; and

FIG. 16 is a diagram showing a holder of a charging apparatus according to a comparative example.

### DETAILED DESCRIPTION OF EMBODIMENTS

A charging apparatus according to an embodiment as an example of the present disclosure will be described below with reference to the drawings. In the drawings, identical or corresponding parts are denoted by identical reference characters, and descriptions therefore are not repeated. In the present specification, "a circumferential direction orthogonal to a certain direction" means a circumferential direction around an imaginary central axis line parallel to the certain direction.

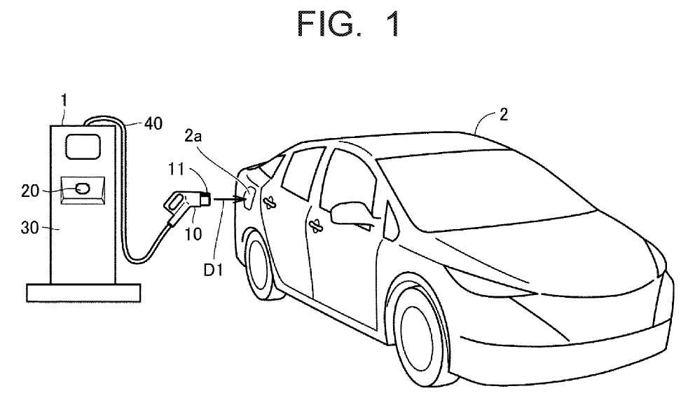

FIG. 1 is a diagram showing a charging apparatus and a vehicle according to an embodiment as an example of the present disclosure. As shown in FIG. 1, a charging apparatus 1 according to the embodiment as the example of the present disclosure is a device for charging a battery mounted on an electrified vehicle 2, and is also called a charging stand. The charging apparatus 1 includes a connector 10, a holder 20, a chassis 30, and a charging cable 40. The charging apparatus 1 may include, for one chassis 30, a plurality of connectors 10, a plurality of holders 20 corresponding to the connectors 10 respectively, and a plurality of charging cables 40 corresponding to the connectors 10 respectively.

First, the connector 10 will be described. The connector 10 is configured to be connected to an inlet 2a of the vehicle 2. The charging apparatus 1 supplies electric power to the vehicle 2 through the connector 10 connected to the inlet 2a. The connector 10 is a so-called handgun type. The connector 10 is provided at a distal end of the charging cable 40 that extends from the chassis 30.

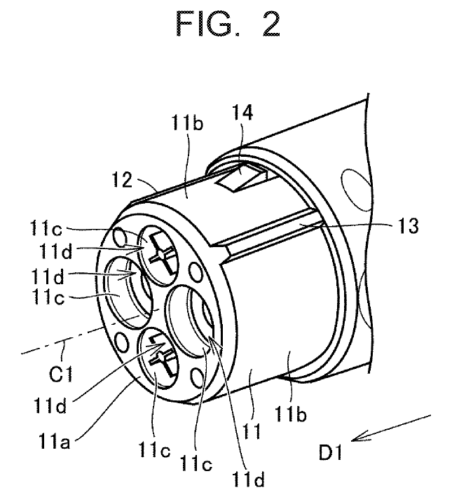

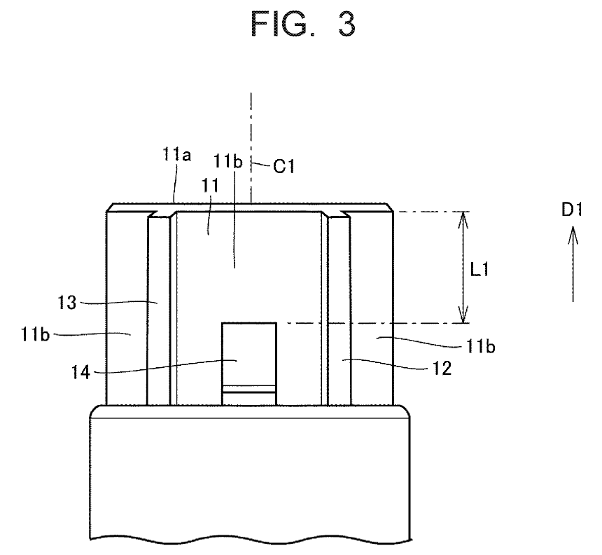

FIG. 2 is a partial perspective view showing the connector. FIG. 3 is a diagram of the connector as viewed from a direction orthogonal to an inserting direction. As shown in FIGS. 1 to 3, the connector 10 includes a distal end portion 11, a first convex portion 12, a second convex portion 13, and a locking portion 14. In the embodiment, the constituents of the connector 10 have structures that conform to a CHAdeMO (R) method. However, the constituents of the connector 10 are not limited to structures that conform to the method.

The distal end portion 11 is configured to be connected to the vehicle 2 by being inserted into the vehicle 2 in an inserting direction D1. The outer shape of the distal end portion 11 is a roughly circular column shape that extends in the inserting direction D1 and in which the center is on an imaginary connector central axis line C1 extending in the inserting direction D1.

The distal end portion 11 includes an end surface 11a, an outer circumferential surface 11b, a plurality of hole portions 11c, and a plurality of connection terminals 11d. The end surface 11a is oriented in the inserting direction D1. The end surface 11a spreads parallel to an imaginary plane orthogonal to the connector central axis line C1. The outer shape of the end surface 11a is a circular shape as viewed from the inserting direction D1.

The outer circumferential surface 11b extends from an end edge of the end surface 11a in the opposite direction of the inserting direction D1. The outer shape of the outer circumferential surface 11b is a roughly cylindrical shape in which the center is on the connector central axis line C1.

The hole portions 11c are formed on the end surface 11a. The hole portions 11c are formed so as to extend from the end surface 11a in the opposite direction of the inserting direction D1.

The connection terminals 11d are positioned in the hole portions 11c respectively. The connection terminals 11d are provided so as not to extend beyond the end surface 11a in the inserting direction D1. When the distal end portion 11 of the connector 10 is connected to the inlet 2a of the vehicle 2, the connection terminals 11d contact with a plurality of terminals of the inlet 2a, that is, a P-terminal and an N-terminal (all not shown), respectively.

The first convex portion 12 protrudes from the distal end portion 11 in a direction intersecting the inserting direction D1 of the distal end portion 11 to the vehicle 2. Specifically, the first convex portion 12 protrudes from the outer circumferential surface 11b. The first convex portion 12 protrudes in a direction orthogonal to the inserting direction D1. The first convex portion 12 extends in a radial direction around the connector central axis line C1. The first convex portion 12 extends parallel to the inserting direction D1. The width size of the first convex portion 12 in a circumferential direction around the connector central axis line C1 is substantially constant. The first convex portion 12 extends over the whole of the outer circumferential surface 11b.

The second convex portion 13 protrudes from the distal end portion 11 in a direction intersecting the inserting direction D1. Specifically, the second convex portion 13 protrudes from the outer circumferential surface 11b. The second convex portion 13 protrudes in a direction orthogonal to the inserting direction D1. The second convex portion 13 extends in a radial direction around the connector central axis line C1. The second convex portion 13 extends parallel to the inserting direction D1. The width size of the second convex portion 13 in the circumferential direction around the connector central axis line C1 is substantially constant. The second convex portion 13 extends over the whole of the outer circumferential surface 11b. The second convex portion 13 is away from the first convex portion 12 in the circumferential direction around the connector central axis line C1.

The locking portion 14 is provided at the distal end portion 11 so as to face in a direction orthogonal to the inserting direction D1. Specifically, the locking portion 14 is provided on the outer circumferential surface 11b. The locking portion 14 is configured to lock the inlet 2a when the distal end portion 11 of the connector 10 is connected to the inlet 2a of the vehicle 2. Further, the locking portion 14 is configured to be relatively displaced from the outer circumferential surface 11b toward the connector central axis line C1. When the locking portion 14 is displaced from the outer circumferential surface 11b in this way, the locking portion 14 is biased in a direction of getting away from the connector central axis line C1. Thereby, just after the insertion of the distal end portion 11 of the connector 10 into the inlet 2a is started, the locking portion 14 is relatively displaced toward the connector central axis line C1, so that the distal end portion 11 is smoothly inserted into the inlet 2a. Further, when the locking portion 14 locks the inlet 2a, the above biasing force allows the connector 10 to be locked by the inlet 2a.

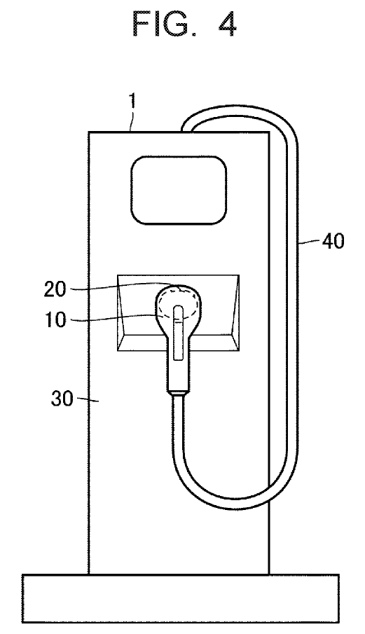

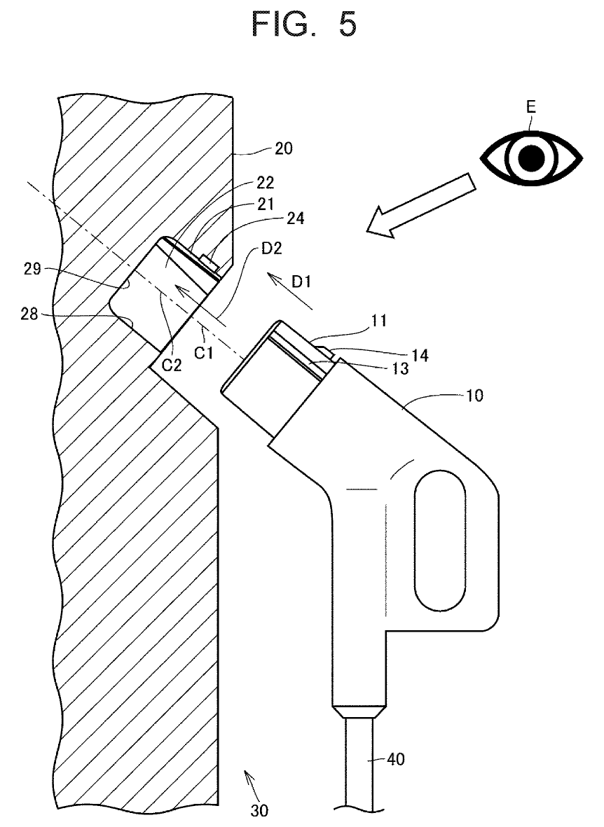

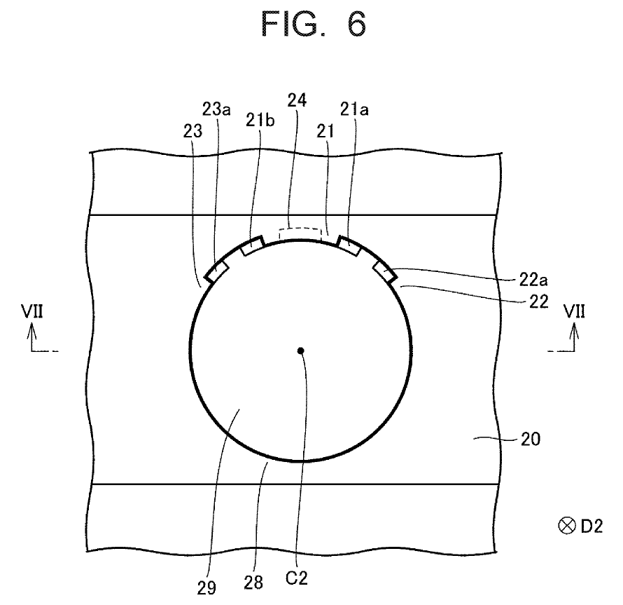

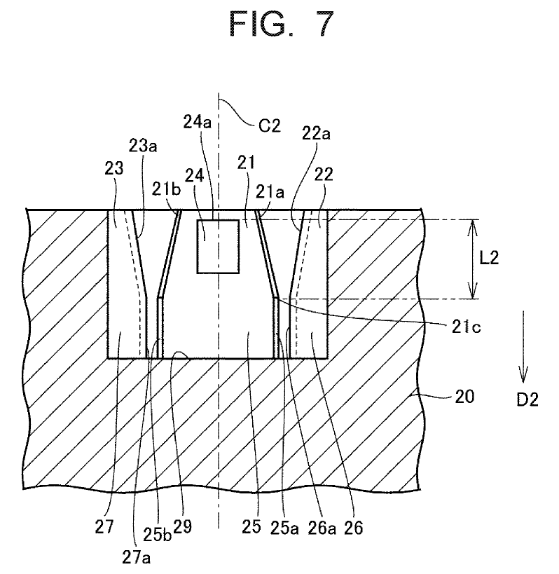

Next, the holder 20 will be described. FIG. 4 is a diagram showing the charging apparatus in a state where the connector is held by the holder. FIG. 5 is a diagram schematically showing a state just before the connector is inserted into the holder. FIG. 6 is a diagram of the holder as viewed along an inserted direction. FIG. 7 is a sectional view of the holder in FIG. 6 as viewed along arrow VII-VII. In FIG. 5, the holder 20 is shown as a sectional view.

As shown in FIGS. 1 and 4 to 7, the holder 20 is configured to hold the connector 10 when the distal end portion 11, the first convex portion 12, the second convex portion 13, and the locking portion 14 have been inserted into the holder 20 such that the inserting direction D1 of the distal end portion 11 is along an inserted direction D2 of the holder 20. The inserted direction D2 is an obliquely upward direction. The holder 20 is provided on the chassis 30. The holder 20 may be provided at a place away from the chassis 30.

The holder 20 includes a first guide portion 21, a second guide portion 22, a third guide portion 23, a locked portion 24, a first wall portion 25, a second wall portion 26, a third wall portion 27, a facing wall portion 28, and an inner wall portion 29. Each of the first guide portion 21, the second guide portion 22, the third guide portion 23, and the facing wall portion 28 extends in an arc-shaped manner around an imaginary holder central axis line C2 extending along the inserted direction D2, when the holder 20 is viewed along the inserted direction D2 (see FIG. 6).

The first guide portion 21 extends along the inserted direction D2. Further, the outer shape of the first guide portion 21 is a roughly trapezoidal shape as viewed from the holder central axis line C2 (see FIG. 7). That is, the first guide portion 21 has such a shape that the size in a circumferential direction around the holder central axis line C2 increases toward the inserted direction D2. The first guide portion 21 includes a surface 21a and a surface 21b. The surface 21a faces the second guide portion 22 in the above circumferential direction, and is inclined so as to get close to the second guide portion 22 toward the inserted direction D2. The surface 21a corresponds to the "first inclined surface" in the present disclosure. The surface 21b faces the third guide portion 23 in the above circumferential direction, and is inclined so as to get close to the third guide portion 23 toward the inserted direction D2.

The second guide portion 22 extends along the inserted direction D2. The second guide portion 22 is arrayed with the first guide portion 21 in a circumferential direction orthogonal to the inserted direction D2. More specifically, the second guide portion 22 is arrayed with the first guide portion 21 at an interval in a circumferential direction around the holder central axis line C2. The second guide portion 22 includes a surface 22a. The surface 22a faces the first guide portion 21 in the above circumferential direction, and is inclined so as to get close to the first guide portion 21 toward the inserted direction D2. The surface 22a corresponds to the "second inclined surface" in the present disclosure.

The first guide portion 21 and the second guide portion 22 are configured such that the distance between the first guide portion 21 and the second guide portion 22 continuously decreases toward the inserted direction D2. In the embodiment, the surface 21a of the first guide portion 21 that is oriented to the second guide portion 22 in the above circumferential direction is inclined so as to get close to the second guide portion 22 toward the inserted direction D2. The surface 22a of the second guide portion 22 that is oriented to the first guide portion 21 in the above circumferential direction is inclined so as to get close to the first guide portion 21 toward the inserted direction D2. Further, a gap between the first guide portion 21 and the second guide portion 22 in the above circumferential direction is positioned on the upper side of the holder central axis line C2. The meaning of "the distance between one portion and another portion continuously decreases toward a predetermined direction" does not include a case where the distance decreases stepwise or discontinuously toward the above predetermined direction. For example, the meaning of "the distance continuously decreases toward the predetermined direction" includes a case where the distance gradually decreases toward the above predetermined direction while facing surfaces of the one portion and the other portion are inclined or curved.

The third guide portion 23 extends along the inserted direction D2. The third guide portion 23 is arrayed with the first guide portion 21 on the opposite side from the second guide portion 22, in a circumferential direction orthogonal to the inserted direction D2. More specifically, the third guide portion 23 is arrayed with the first guide portion 21 at an interval, on the opposite side from the second guide portion 22, in a circumferential direction around the holder central axis line C2. The third guide portion 23 includes a surface 23a. The surface 23a faces the first guide portion 21 in the above circumferential direction, and is inclined so as to get close to the first guide portion 21 toward the inserted direction D2.

The first guide portion 21 and the third guide portion 23 are configured such that the distance between the first guide portion 21 and the third guide portion 23 continuously decreases toward the inserted direction D2. In the embodiment, the surface 21b of the first guide portion 21 that is oriented to the third guide portion 23 in the above circumferential direction is inclined so as to get close to the third guide portion 23 toward the inserted direction D2. The surface 23a of the third guide portion 23 that is oriented to the first guide portion 21 in the above circumferential direction is inclined so as to get close to the first guide portion 21 toward the inserted direction D2. Further, a gap between the first guide portion 21 and the third guide portion 23 in the above circumferential direction is positioned on the upper side of the holder central axis line C2.

The locked portion 24 is locked by the locking portion 14 when the connector 10 has been inserted into the holder 20, and thereby, the connector 10 can be held in the holder 20. More specifically, the locking portion 14 locks the locked portion 24 in the opposite direction of the inserted direction D2, and thereby, the connector 10 is held by the holder 20. The locked portion 24 is formed at the first guide portion 21. The locked portion 24 is formed so as to be dented from a surface of the first guide portion 21 that is oriented to the holder central axis line C2, toward a radial direction around the holder central axis line C2. The locked portion 24 is provided at the first wall portion 25 described later. A size (L2) in the inserted direction D2 from a distal end part 21c of the first guide portion 21 in the inserted direction D2 to a rear end edge 24a of the locked portion 24 in the inserted direction D2 is shorter than a size (L1) in the inserting direction D1 from a distal end of the first convex portion 12 to the locking portion 14 (see FIG. 3).

The first wall portion 25 extends from the first guide portion 21 in the inserted direction D2 (see FIG. 7). Specifically, the first wall portion 25 further extends from the distal end part 21c of the first guide portion 21 in the inserted direction D2. The outer shape of the first wall portion 25 is a rectangular shape as viewed from the holder central axis line C2.

The second wall portion 26 and the third wall portion 27 extend from the second guide portion 22 and the third guide portion 23 in the inserted direction D2, respectively. Each outer shape of the second wall portion 26 and the third wall portion 27 is a rectangular shape as viewed from the holder central axis line C2.

A surface 25a of the first wall portion 25 that is oriented to the second wall portion 26 in the above circumferential direction is continuous with the surface 21a of the first guide portion 21 that is oriented to the second guide portion 22, in the inserted direction D2, and extends parallel to the inserted direction D2. A surface 25b of the first wall portion 25 that is oriented to the third wall portion 27 in the above circumferential direction is continuous with the surface 21b of the first guide portion 21 that is oriented to the third guide portion 23, in the inserted direction D2, and extends parallel to the inserted direction D2.

A surface 26a of the second wall portion 26 that is oriented to the first wall portion 25 in the above circumferential direction is continuous with the surface 22a of the second guide portion 22 that is oriented to the first guide portion 21, in the inserted direction D2, and extends parallel to the inserted direction D2. A surface 27a of the third wall portion 27 that is oriented to the first wall portion 25 in the above circumferential direction is continuous with the surface 23a of the third guide portion 23 that is oriented to the first guide portion 21, in the inserted direction D2, and extends parallel to the inserted direction D2.

The facing wall portion 28 is positioned on the lower side of the holder central axis line C2. The facing wall portion 28 faces the first guide portion 21, the second guide portion 22, the third guide portion 23, the locked portion 24, the first wall portion 25, and the second wall portion 26, in a direction orthogonal to the inserted direction D2. The facing wall portion 28 is connected to the second guide portion 22, the third guide portion 23, the second wall portion 26, and the third wall portion 27, in the above circumferential direction.

The inner wall portion 29 is positioned at a distal end of the holder 20 in the inserted direction D2. The inner wall portion 29 spreads parallel to an imaginary plane orthogonal to the inserted direction D2. The inner wall portion 29 may be provided with a plurality of fitting portions that can be fit to the hole portions 11c (see FIG. 2) of the connector 10 respectively. The inner wall portion 29 is connected to the first wall portion 25, the second wall portion 26, the third wall portion 27, and the facing wall portion 28.

Next, the motion of the connector 10 when a worker performs the positioning of the connector 10 with respect to the holder 20 for inserting the connector 10 into the holder 20, inserts the connector 10 into the holder 20, and causes the holder 20 to hold the connector 10 will be described.

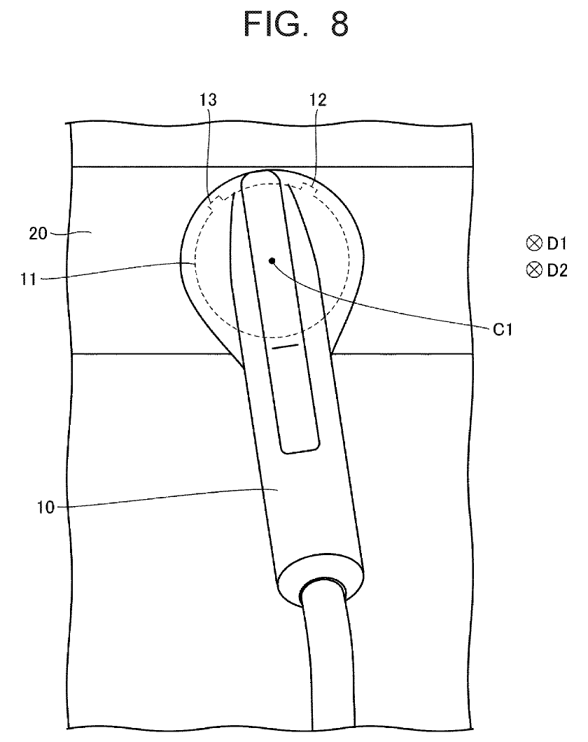

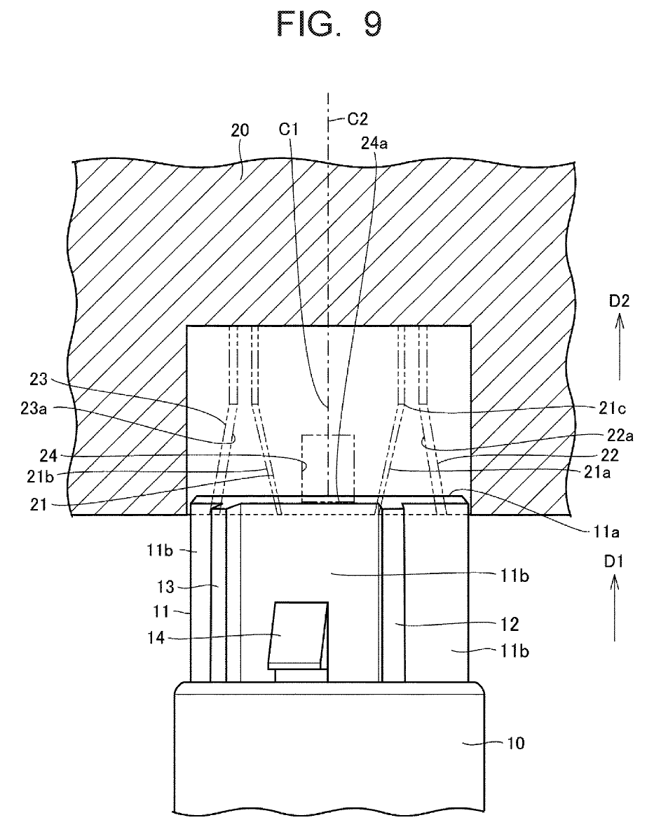

FIG. 8 is a diagram showing an example of a state just after the insertion of the connector into the holder is started, as viewed along the inserted direction. FIG. 9 is a schematic diagram showing the example of the state just after the insertion of the connector into the holder is started, as viewed in a direction orthogonal to the inserted direction. In FIG. 9 and some schematic diagrams described later, for convenience, only the holder 20 is shown as a sectional view.

The worker roughly performs the positioning such that the connector central axis line C1 of the connector 10 matches the holder central axis line C2 of the holder 20 (see FIG. 5), and thereafter, starts the insertion of the distal end portion 11 into the holder 20, as shown in FIGS. 8 and 9. At this time, as viewed in the inserted direction D2, the distal end portion 11 is in a state of being rotated around the connector central axis line C1 counterclockwise, compared to the final state of being held by the holder 20. However, the first convex portion 12 is slid on the surface 21a of the first guide portion 21, and the second convex portion 13 is slid on the surface 23a of the third guide portion 23, so that the distal end portion 11 is turned around the connector central axis line C1 clockwise while advancing in the inserted direction D2.

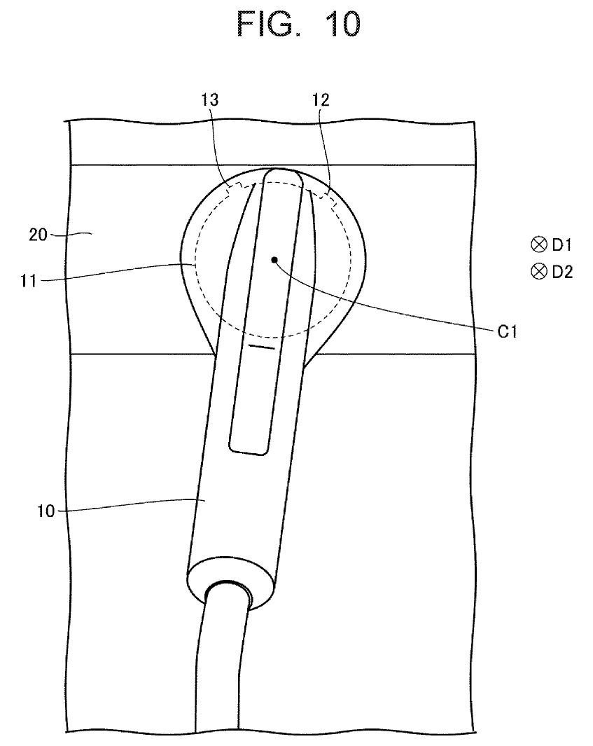

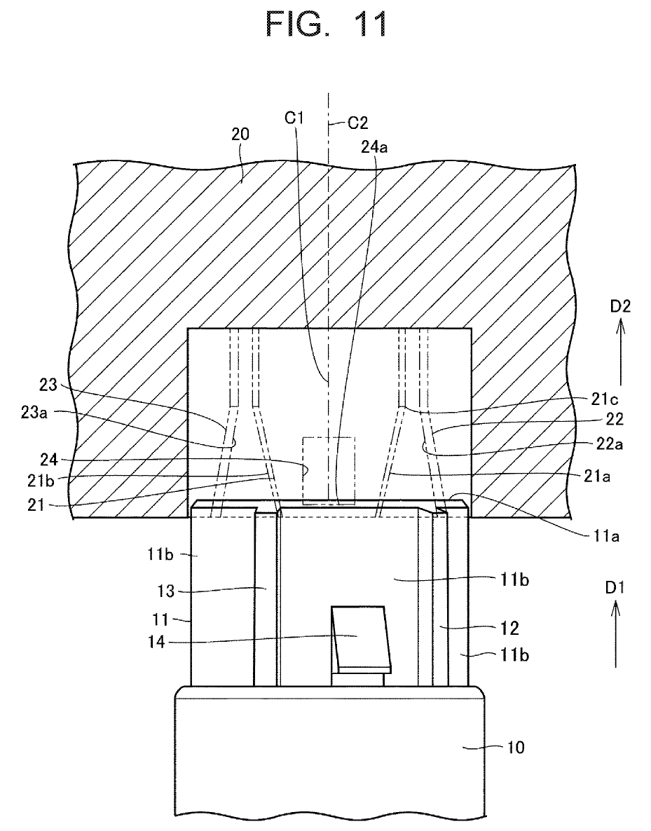

FIG. 10 is a diagram showing a different example of the state just after the insertion of the connector into the holder is started, as viewed along the inserted direction. FIG. 11 is a schematic diagram showing the different example of the state just after the insertion of the connector into the holder is started, as viewed in the direction orthogonal to the inserted direction. As shown in FIGS. 10 and 11, when the worker starts the insertion of the connector 10 into the holder 20, the distal end portion 11 is in a state of being rotated around the connector central axis line C1 clockwise, compared to the final state of being held by the holder 20. However, the first convex portion 12 is slid on the surface 22a of the second guide portion 22, and the second convex portion 13 is slid on the surface 21b of the first guide portion 21, so that the distal end portion 11 is turned around the connector central axis line C1 counterclockwise while advancing in the inserted direction D2.

In this way, the first guide portion 21 and the second guide portion 22 are provided such that the first convex portion 12 passes between the first guide portion 21 and the second guide portion 22 after the insertion of the distal end portion 11 into the holder 20 is started. Further, the first guide portion 21 and the third guide portion 23 are provided such that the second convex portion 13 passes between the first guide portion 21 and the third guide portion 23 after the insertion of the distal end portion 11 into the holder 20 is started. Furthermore, a gap between the first guide portion 21 and the second guide portion 22 may be positioned on the upper side of the distal end portion 11 when the distal end portion 11 has been inserted into the holder 20 (see FIG. 5).

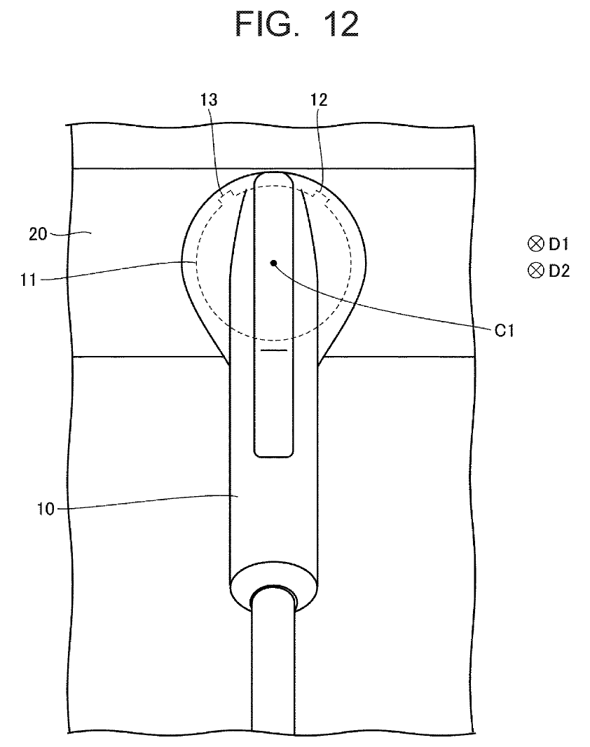

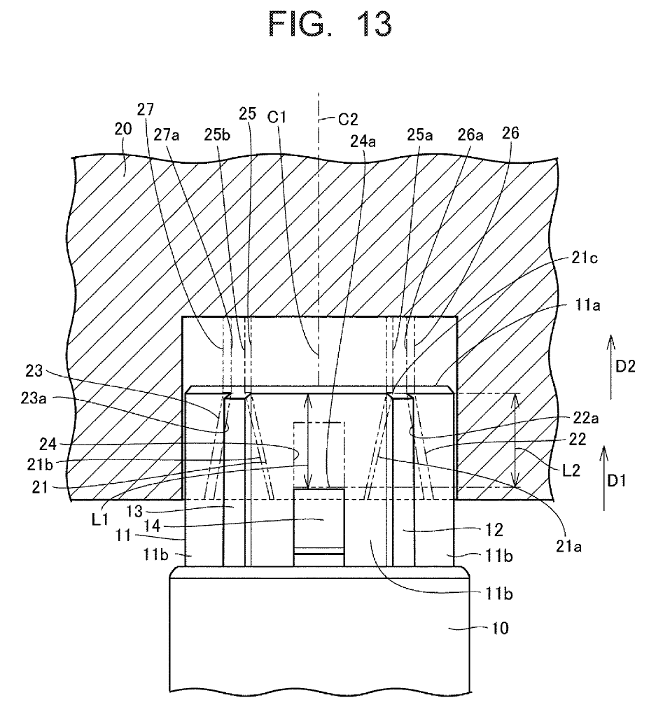

FIG. 12 is a diagram showing a state where the first convex portion has advanced to the distal end part of the first guide portion, as viewed along the inserted direction. FIG. 13 is a schematic diagram showing the state where the first convex portion has advanced to the distal end part of the first guide portion, as viewed in the direction orthogonal to the inserted direction. As shown in FIGS. 12 and 13, when the worker further presses the connector 10 in the inserted direction D2 and thereby the first convex portion 12 and the distal end part 21c of the first guide portion 21 are arrayed in the circumferential direction (see FIG. 13), the posture of the distal end portion 11 is corrected to the same posture as a posture when the distal end portion 11 is finally held by the holder 20, as viewed along the inserted direction D2 (see FIG. 12).

The size (L2) in the inserted direction D2 from the distal end part 21c of the first guide portion 21 in the inserted direction D2 to the rear end edge 24a of the locked portion 24 in the inserted direction D2 is shorter than the size (L1) in the inserting direction D1 from the distal end of the first convex portion 12 to the locking portion 14. Therefore, in the state shown in FIGS. 12 and 13, the locking portion 14 does not overlap with the locked portion 24 in the radial direction. In this way, the locked portion 24 is configured not to be locked by the locking portion 14 when the distal end of the first convex portion 12 in the inserting direction D1 is positioned between the first guide portion 21 and the second guide portion 22.

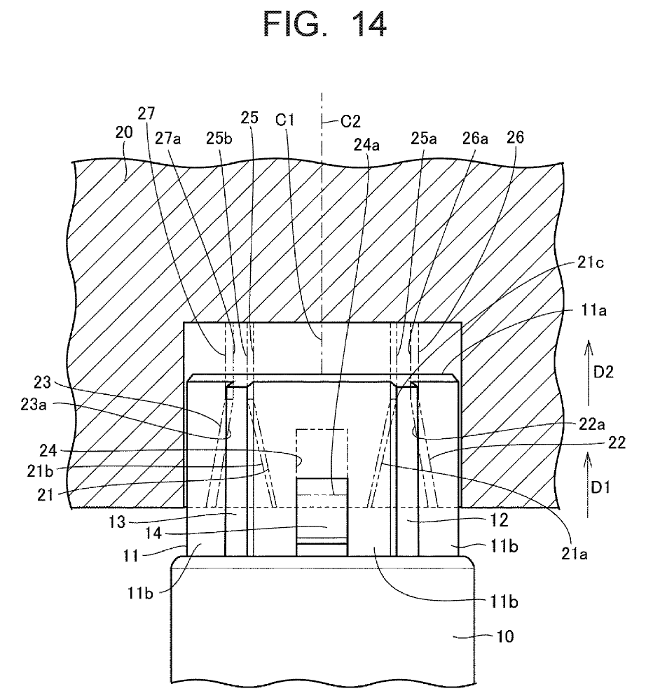

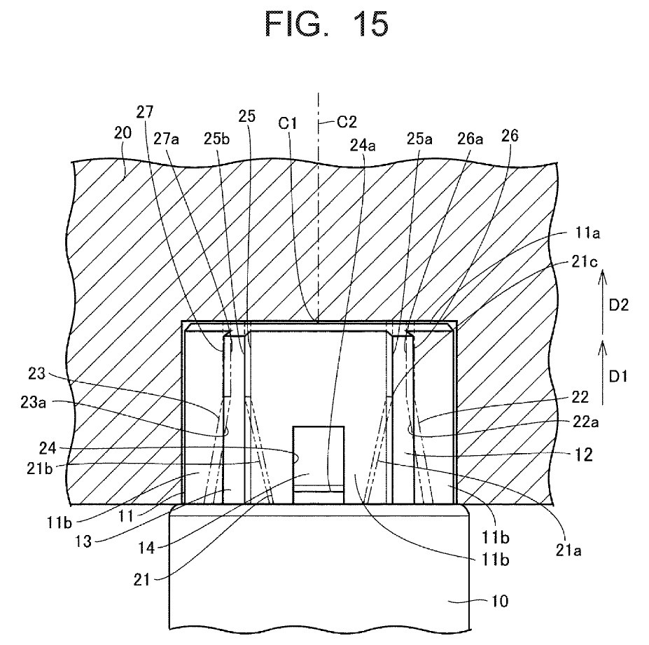

FIG. 14 is a schematic diagram showing a state where the first convex portion is advancing between the first wall portion and the second wall portion, as viewed in the direction orthogonal to the inserted direction. FIG. 15 is a schematic diagram showing a state where the connector is held by the holder, as viewed in the direction orthogonal to the inserted direction. As shown in FIGS. 14 and 15, when the worker further presses the connector 10 in the inserted direction D2, the first convex portion 12 is slid on at least one of the surface 25a of the first wall portion 25 or the surface 26a of the second wall portion 26, and the second convex portion 13 is slid on at least one of the surface 25b of the first wall portion 25 or the surface 27a of the third wall portion 27. Thereby, the distal end portion 11 advances in the inserted direction D2 while the posture in the circumferential direction as viewed in the inserted direction D2 is substantially maintained (see FIG. 14). Then, when the worker further presses the connector 10 in the inserted direction D2, the locking portion 14 locks the locked portion 24. In this way, the locked portion 24 is configured to be locked by the locking portion 14 when the distal end of the first convex portion 12 is positioned beyond the first guide portion 21 and the second guide portion 22 in the inserted direction D2. In the embodiment, the locking portion 14 locks the locked portion 24 in the opposite direction of the inserted direction D2, and locks the locked portion 24 on both sides in the circumferential direction around the holder central axis line C2. Thereby, the connector 10 is held by the holder 20.

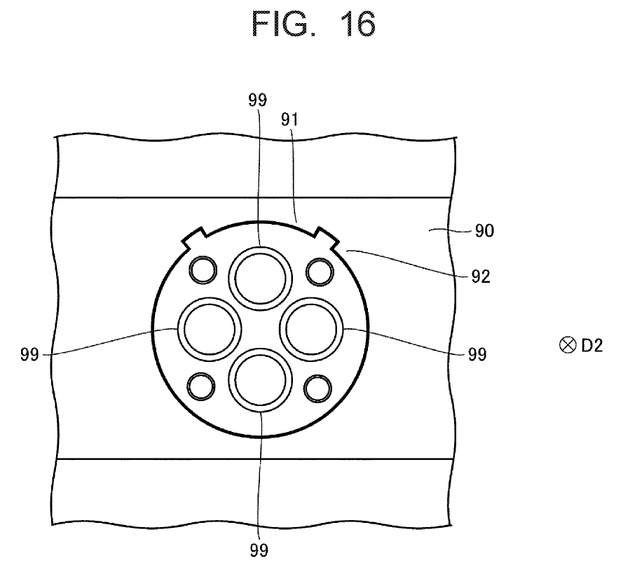

A holder according to a comparative example will be described. FIG. 16 is a diagram showing a holder of a charging apparatus according to a comparative example. In a holder 90 according to the comparative example, the interval distance between the first guide portion 91 and the second guide portion 92 in the circumferential direction is constant in the inserted direction D2. Further, the interval distance is set so as to be substantially equal to the size of the first convex portion 12 in the circumferential direction of the connector 10. Therefore, it is not easy for the worker to perform the positioning of the connector 10 before the insertion with respect to the holder 20, for putting the first convex portion 12 into between the first guide portion 91 and the second guide portion 92. Further, the holder 90 includes a plurality of fitting portions 99 that can be fit to the hole portions 11c (see FIG. 2) of the connector 10 respectively. The fitting portions 99 can also make it difficult to perform the positioning of the connector 10 with respect to the holder 20.

On the other hand, as described above, the charging apparatus 1 according to the embodiment as an example of the present disclosure includes the connector 10 and the holder 20. The connector 10 includes the distal end portion 11 and the first convex portion 12. The distal end portion 11 is configured to be connected to the vehicle 2 by being inserted into the vehicle 2. The first convex portion 12 protrudes from the distal end portion 11 in the direction intersecting the inserting direction D1 of the distal end portion 11 to the vehicle 2. The holder 20 is configured to hold the connector 10 when the distal end portion 11 and the first convex portion 12 have been inserted into the holder 20 such that the inserting direction D1 of the distal end portion 11 is along the inserted direction D2 of the holder 20. The holder 20 includes the first guide portion 21 and the second guide portion 22. The first guide portion 21 and the second guide portion 22 are arrayed in the circumferential direction orthogonal to the inserted direction D2, and extend along the inserted direction D2. The distance between the first guide portion 21 and the second guide portion 22 continuously decreases toward the inserted direction D2.

In the above configuration, the distal end portion 11 is inserted into the holder 20 such that the first convex portion 12 passes between the first guide portion 21 and the second guide portion 22. Thereby, as the distal end portion 11 advances in the inserted direction D2, the first convex portion 12 is guided by the first guide portion 21 and the second guide portion 22, for which the distance therebetween continuously decreases, and thereby, is displaced in the circumferential direction orthogonal to the inserted direction D2. Thereby, the posture of the distal end portion 11 is corrected. On the other hand, the distance between the first guide portion 21 and the second guide portion 22 increases toward the opposite direction of the inserted direction D2, and therefore, the worker can easily arrange the first convex portion 12 between the first guide portion 21 and the second guide portion 22. Consequently, it is easy to perform the positioning of the connector 10 at the start of the insertion into the holder 20.

Further, in the embodiment, the first guide portion 21 and the second guide portion 22 are provided such that the first convex portion 12 passes between the first guide portion 21 and the second guide portion 22 after the insertion of the distal end portion 11 into the holder 20 is started.

In the above configuration, the worker can cause the first convex portion 12 to more surely pass between the first guide portion 21 and the second guide portion 22. Consequently, it is possible to more easily perform the positioning of the connector 10 at the start of the insertion into the holder 20.

Further, in the embodiment, the first guide portion 21 includes the first inclined surface. The first inclined surface faces the second guide portion 22 in the above circumferential direction, and is inclined so as to get close to the second guide portion 22 toward the inserted direction D2. The second guide portion 22 includes the second inclined surface. The second inclined surface faces the first guide portion 21 in the above circumferential direction, and is inclined so as to get close to the first guide portion 21 toward the inserted direction D2.

In the above configuration, as the distal end portion 11 is inserted into the holder 20 and the distal end portion 11 advances in the inserted direction D2, the first convex portion 12 is more smoothly guided by the first guide portion 21 and the second guide portion 22. Thereby, the worker can easily press the distal end portion 11.

Further, in the embodiment, the connector 10 further includes the locking portion 14. The locking portion 14 is provided at the distal end portion 11 so as to face in the direction intersecting the inserting direction D1. The holder 20 further includes the first wall portion 25, the second wall portion 26, and the locked portion 24. The first wall portion 25 extends from the first guide portion 21 in the inserted direction D2. The second wall portion 26 extends from the second guide portion 22 in the inserted direction D2. The locked portion 24 is formed at the first guide portion 21 or the first wall portion 25. The locking portion 14 locks the locked portion 24 in the opposite direction of the inserted direction D2, and thereby, the connector 10 is held by the holder 20. When the locking portion 14 has locked the locked portion 24, the distal end of the first convex portion 12 in the inserting direction D1 is positioned between the first wall portion 25 and the second wall portion 26.

In the above configuration, in the process of the insertion of the distal end portion 11 into the holder 20, when the distal end of the first convex portion 12 in the inserting direction D1 is positioned between the first guide portion 21 and the second guide portion 22 that are positioned short of the first wall portion 25 and the second wall portion 26 in the inserted direction D2, the locking portion 14 does not lock the locked portion 24 in the opposite direction of the inserted direction D2. Accordingly, it is possible to prevent the locking portion 14 from locking the locked portion 24 before the finish of the correction of the posture of the distal end portion 11 by the first guide portion 21 and the second guide portion 22.

Further, in the embodiment, the locked portion 24 is formed at the first guide portion 21. The size in the inserted direction D2 from the distal end part 21c of the first guide portion 21 in the inserted direction D2 to the rear end edge 24a of the locked portion 24 in the inserted direction D2 is shorter than the size in the inserting direction D1 from the distal end of the first convex portion 12 to the locking portion 14.

In the above configuration, in the case where the locked portion 24 is formed at the first guide portion 21, it is possible to prevent the locking portion 14 from locking the locked portion 24 before the finish of the correction of the posture of the distal end portion 11 by the first guide portion 21 and the second guide portion 22 in the process of the insertion of the distal end portion 11 into the holder 20.

Further, in the embodiment, the first convex portion 12 extends parallel to the insertion direction D1. The holder 20 further includes the first wall portion 25 and the second wall portion 26. The first wall portion 25 extends from the first guide portion 21 in the inserted direction D2. The second wall portion 26 extends from the second guide portion 22 in the inserted direction D2. The surface of the first wall portion 25 that is oriented to the second wall portion 26 is continuous with the surface of the first guide portion 21 that is oriented to the second guide portion 22, in the inserted direction D2, and extends parallel to the inserted direction D2. The surface of the second wall portion 26 that is oriented to the first wall portion 25 is continuous with the surface of the second guide portion 22 that is oriented to the first guide portion 21, in the inserted direction D2, and extends parallel to the inserted direction D2.

In the above configuration, in the case where the first convex portion 12 extends parallel to the inserting direction D1, the first convex portion 12 is put into between the first wall portion 25 and the second wall portion 26, after the finish of the positioning of the distal end of the first convex portion 12 by the first guide portion 21 and the second guide portion 22, and thereby, the position aberration of the first convex portion 12 during the insertion of the distal end portion 11 is restrained.

Further, in the embodiment, the inserted direction D2 is an obliquely upward direction. The gap between the first guide portion 21 and the second guide portion 22 is positioned on the upper side of the distal end portion 11 when the distal end portion 11 has been inserted into the holder 20.

In the above configuration, in the case where an observing point (shown by a reference character "E" in FIG. 5) of the worker that places the connector 10 in the holder 20 is positioned above the holder 20, it is difficult to directly see the holder 20 in the inserted direction D2. However, since the gap between the first guide portion 21 and the second guide portion 22 is at the above-described position, the worker can insert the distal end portion 11 into the holder 20 while visually observing the first convex portion 12.

Further, in the embodiment, the connector 10 further includes the second convex portion 13. The second convex portion 13 protrudes from the distal end portion 11 in the direction intersecting the inserting direction D1. The holder 20 further includes the third guide portion 23. The third guide portion 23 is arrayed with the first guide portion 21 in the circumferential direction orthogonal to the inserted direction D2, and extends along the inserted direction D2. The distance between the first guide portion 21 and the third guide portion 23 continuously decreases toward the inserted direction D2.

In the above configuration, the distal end portion 11 is inserted into the holder 20 such that the second convex portion 13 further passes between the first guide portion 21 and the third guide portion 23. Thereby, as the distal end portion 11 advances in the inserted direction D2, the second convex portion 13 is guided by the first guide portion 21 and the third guide portion 23, for which the distance therebetween continuously decreases, and thereby, is displaced in the circumferential direction orthogonal to the inserted direction D2. Thereby, the posture of the distal end portion 11 is corrected also by the second convex portion 13. On the other hand, the distance between the first guide portion 21 and the third guide portion 23 increases toward the opposite direction of the inserted direction D2, and therefore, the worker can easily arrange the second convex portion 13 between the first guide portion 21 and the third guide portion 23. Consequently, even in the case where the connector 10 includes the first convex portion 12 and the second convex portion 13, it is easy to perform the positioning of the connector 10 at the start of the insertion into the holder 20.

Further, in the embodiment, the first guide portion 21 and the third guide portion 23 are provided such that the second convex portion 13 passes between the first guide portion 21 and the third guide portion 23 after the insertion of the distal end portion 11 into the holder 20 is started.

In the above configuration, the worker can cause the second convex portion 13 to more surely pass between the first guide portion 21 and the third guide portion 23. Consequently, even in the case where the connector 10 includes the first convex portion 12 and the second convex portion 13, it is possible to more easily perform the positioning of the connector 10 at the start of the insertion into the holder 20.

In the above-described embodiment, configurations that can be combined may be mutually combined.

The embodiment disclosed herein should be considered in all respects as illustrative and not restrictive. The scope of the present disclosure is defined by the claims rather than the foregoing description, and is intended to include all alterations within the meaning and scope equivalent to the claims.

What is claimed is:

1. A charging apparatus comprising:
a connector; and
a holder, wherein:
the connector includes a distal end portion and a first convex portion,
the distal end portion is configured to be connected to a vehicle by being inserted into the vehicle;
the first convex portion protrudes from the distal end portion in a direction intersecting an inserting direction of the distal end portion to the vehicle,
the holder is configured to hold the connector when the distal end portion and the first convex portion have been inserted into the holder such that the inserting direction of the distal end portion is along an inserted direction of the holder,
the holder includes a first guide portion and a second guide portion,
the first guide portion and the second guide portion are arrayed in a circumferential direction orthogonal to the inserted direction, and extend along the inserted direction, and
a distance between the first guide portion and the second guide portion continuously decreases toward the inserted direction.

2. The charging apparatus according to claim 1, wherein an outer shape of the first guide portion is a roughly trapezoidal shape as viewed from a central axis line of the holder.

3. The charging apparatus according to claim 1, wherein the first guide portion and the second guide portion are provided such that the first convex portion passes between the first guide portion and the second guide portion after the insertion of the distal end portion into the holder is started.

4. The charging apparatus according to claim 1, wherein:
the first guide portion includes a first inclined surface, and the first inclined surface faces the second guide portion in the circumferential direction and is inclined so as to get close to the second guide portion toward the inserted direction; and
the second guide portion includes a second inclined surface, and the second inclined surface faces the first guide portion in the circumferential direction and is inclined so as to get close to the first guide portion toward the inserted direction.

5. The charging apparatus according to claim 1, wherein:
the connector further includes a locking portion;
the locking portion is provided at the distal end portion so as to face in a direction intersecting the inserting direction;
the holder further includes a first wall portion, a second wall portion, and a locked portion;
the first wall portion extends from the first guide portion in the inserted direction;
the second wall portion extends from the second guide portion in the inserted direction;
the locked portion is provided at one of the first guide portion and the first wall portion;
the locking portion locks the locked portion in an opposite direction of the inserted direction, such that the connector is held by the holder; and
a distal end of the first convex portion in the inserting direction is positioned between the first wall portion and the second wall portion, when the locking portion has locked the locked portion.

6. The charging apparatus according to claim 5, wherein:
the locked portion is provided at the first guide portion; and
a size in the inserted direction from a distal end part of the first guide portion in the inserted direction to a rear end edge of the locked portion in the inserted direction is shorter than a size in the inserting direction from the distal end of the first convex portion to the locking portion.

7. The charging apparatus according to claim 1, wherein:
the first convex portion extends parallel to the inserting direction;
the holder further includes a first wall portion and a second wall portion;
the first wall portion extends from the first guide portion in the inserted direction;
the second wall portion extends from the second guide portion in the inserted direction;
a surface of the first wall portion is continuous with a surface of the first guide portion in the inserted direction, and extends parallel to the inserted direction, the surface of the first wall portion being oriented to the second wall portion, the surface of the first guide portion being oriented to the second guide portion; and
a surface of the second wall portion is continuous with a surface of the second guide portion in the inserted direction, and extends parallel to the inserted direction, the surface of the second wall portion being oriented to the first wall portion, the surface of the second guide portion being oriented to the first guide portion.

8. The charging apparatus according to claim 1, wherein:
the inserted direction is an obliquely upward direction; and
a gap between the first guide portion and the second guide portion is positioned on an upper side of the distal end portion when the distal end portion has been inserted into the holder.

9. The charging apparatus according to claim 1, wherein:
the connector further includes a second convex portion;
the second convex portion protrudes from the distal end portion in a direction intersecting the inserting direction;
the holder further includes a third guide portion;
the third guide portion is arrayed with the first guide portion in the circumferential direction orthogonal to the inserted direction, and extends along the inserted direction; and
a distance between the first guide portion and the third guide portion continuously decreases toward the inserted direction.

10. The charging apparatus according to claim 9, wherein the first guide portion and the third guide portion are provided such that the second convex portion passes between the first guide portion and the third guide portion after the insertion of the distal end portion into the holder is started.
